(19) United States
(12) Patent Application Publication
(10) Pub. No.: US 2022/0164153 A1
(43) Pub. Date: May 26, 2022

(54) METHODS, SYSTEMS, AND DEVICES FOR ADJUSTING CONTENT LAYERS WITHIN MEDIA CONTENT

(71) Applicant: AT&T Intellectual Property I, L.P., Atlanta, GA (US)

(72) Inventors: Eric Zavesky, Austin, TX (US); David Crawford Gibbon, Lincroft, NJ (US); James H. Pratt, ROUND ROCK, TX (US)

(73) Assignee: AT&T Intellectual Property I, L.P., Atlanta, GA (US)

(21) Appl. No.: 17/103,046

(22) Filed: Nov. 24, 2020

(51) Int. Cl. G06F 3/14

(52) U.S. Cl. CPC G06F 3/1423

(57) ABSTRACT

Aspects of the subject disclosure may include, for example, receiving a group of content layers from a group of media content sources, and identifying metadata for each of the group of content layers resulting in a group of metadata. Further embodiments can include obtaining a group of user preferences, and selecting a first portion of the group of content layers according to the group of metadata and the group of user preferences resulting in a first selected portion of the group of content layers. Additional embodiments can include providing first instructions to a first display of a first communication device to present the first selected portion of the group of content layers resulting in a first presentation. Other embodiments are disclosed.

### FIELD OF THE DISCLOSURE

The subject disclosure relates to methods, systems, and devices for adjusting content layers within media content.

### BACKGROUND

A communication device can receive media content from different media content sources, each piece of media content can then be layered to build a richer media content to present to a user. However, the communication device receives no guidance from any of the media content sources to present the different content layers such that they do not conflict, interfere or obscure with one another. Further, the different media content sources provide no guidance to adjust the media content according to a specific user associated with the communication device.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIGS. 2A-2E are block diagrams illustrating example, non-limiting embodiments of systems functioning within the communication network of FIG. 1 in accordance with various aspects described herein.

FIGS. 2F-H depict illustrative embodiments of methods in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for receiving a group of content layers from a group of media content sources, and identifying metadata for each of the group of content layers resulting in a group of metadata. Further embodiments can include obtaining a group of user preferences, and selecting a first portion of the group of content layers according to the group of metadata and the group of user preferences resulting in a first selected portion of the group of content layers. Additional embodiments can include providing first instructions to a first display of a first communication device to present the first selected portion of the group of content layers resulting in a first presentation. Other embodiments are described in the subject disclosure.

One or more aspects of the subject disclosure include a device, comprising: a processing system including a processor, and a memory that stores executable instructions that, when executed by the processing system, facilitate performance of operations. The operations can comprise receiving a group of content layers from a group of media content sources, and identifying metadata for each of the group of content layers resulting in a group of metadata. Further operations can comprise obtaining a group of user preferences, and selecting a first portion of the group of content layers according to the group of metadata and the group of user preferences resulting in a first selected portion of the group of content layers. Additional operations can comprise providing first instructions to a first display of a first communication device to present the first selected portion of the group of content layers resulting in a first presentation.

One or more aspects of the subject disclosure include a machine-readable medium, comprising executable instructions that, when executed by a processing system including a processor, facilitate performance of operations. The operations can comprise receiving a group of content layers from a group of media content sources, and identifying metadata for each of the group of content layers resulting in a group of metadata. Further operations can comprise obtaining a group of user preferences, and selecting a first portion of the group of content layers according to the group of metadata, the group of user preferences, and a second portion of the group of content layers resulting in a first selected portion of the group of content layers. Additional operations can include providing first instructions to a first display of a first communication device to present the first selected portion of the group of content layers resulting in a first presentation, wherein the second portion of the group of content layers distracts from the first selected portion of the group of content layers when the first selected portion of the group of content layers and the second portion of the group of content layers are presented on the first display simultaneously.

One or more aspects of the subject disclosure include a method. The method can comprise receiving, by a processing system including a processor, a group of content layers from a group of media content sources, and identifying, by the processing system, metadata for each of the group of content layers resulting in a group of metadata. Further, the method can comprise obtaining, by the processing system, a group of user preferences, and selecting, by the processing system, a first portion of the group of content layers according to the group of metadata and the group of user preferences resulting in a first selected portion of the group of content layers. In addition, the method can comprise providing, by the processing system, first instructions to a first display of a first communication device to present the first selected portion of the group of content layers resulting in a first presentation. The first instructions comprise instructions to adjust a first content layer in the first selected portion of the group of content layers according to a second content layer in the first selected portion of the group of content layers, wherein the first content layer in the first selected portion of the group of content layers distracts from the second content layer in the first selected portion of the group of content layers when the first content layer in the first selected portion of the group of content layers and the second content layer in the first selected portion of the group of content layers are presented on the first display.

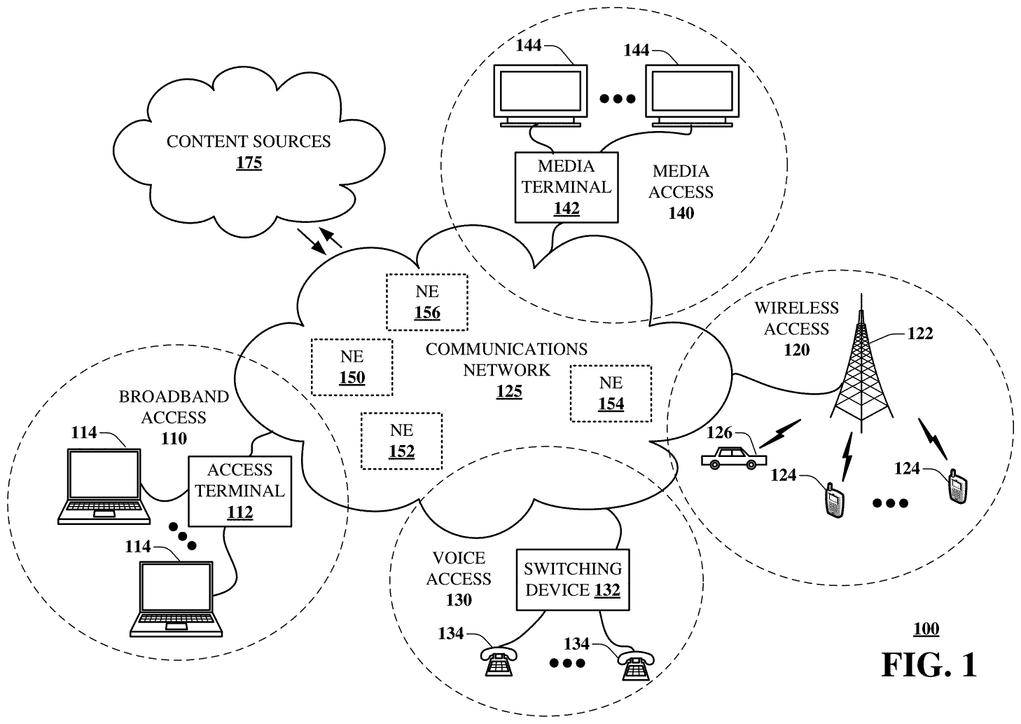

Referring now to FIG. 1, a block diagram is shown illustrating an example, non-limiting embodiment of a system 100 in accordance with various aspects described herein. For example, system 100 can facilitate in whole or in part selecting a portion of media content layers to present on a communication device of a user based on metadata of the content layers as well as user preferences, and providing instructions to the display of the communication device accordingly. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

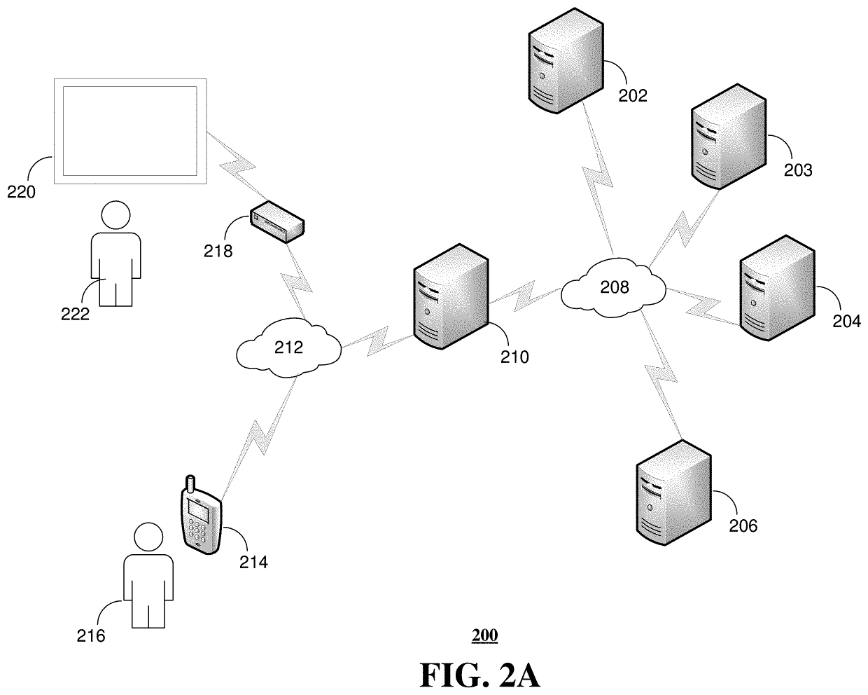

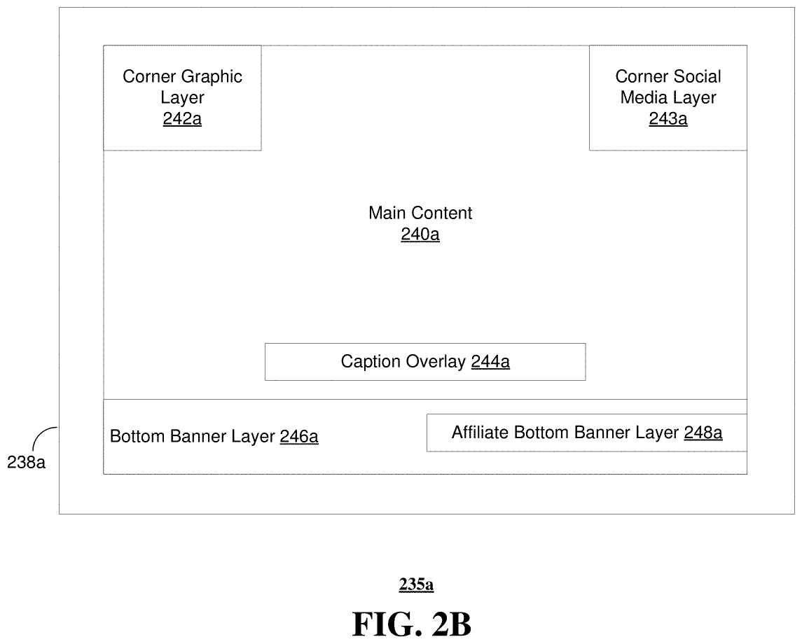

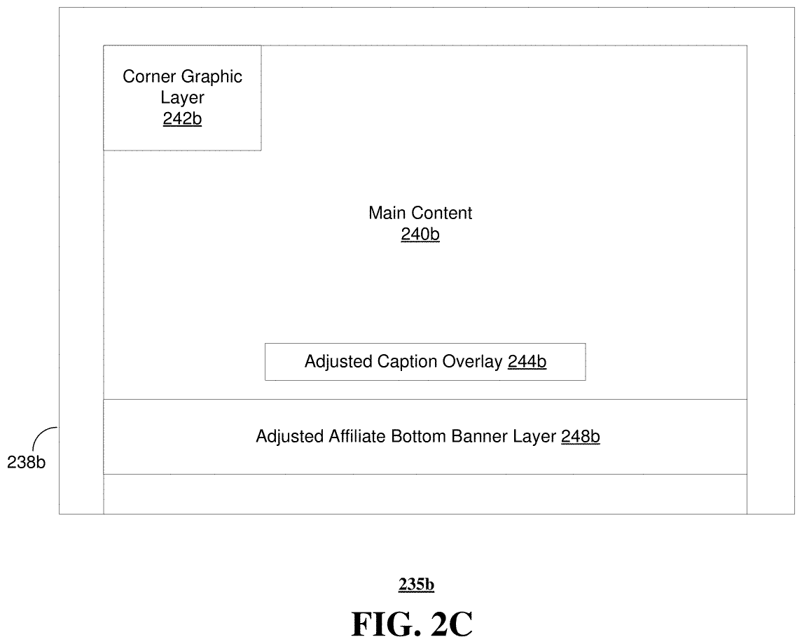

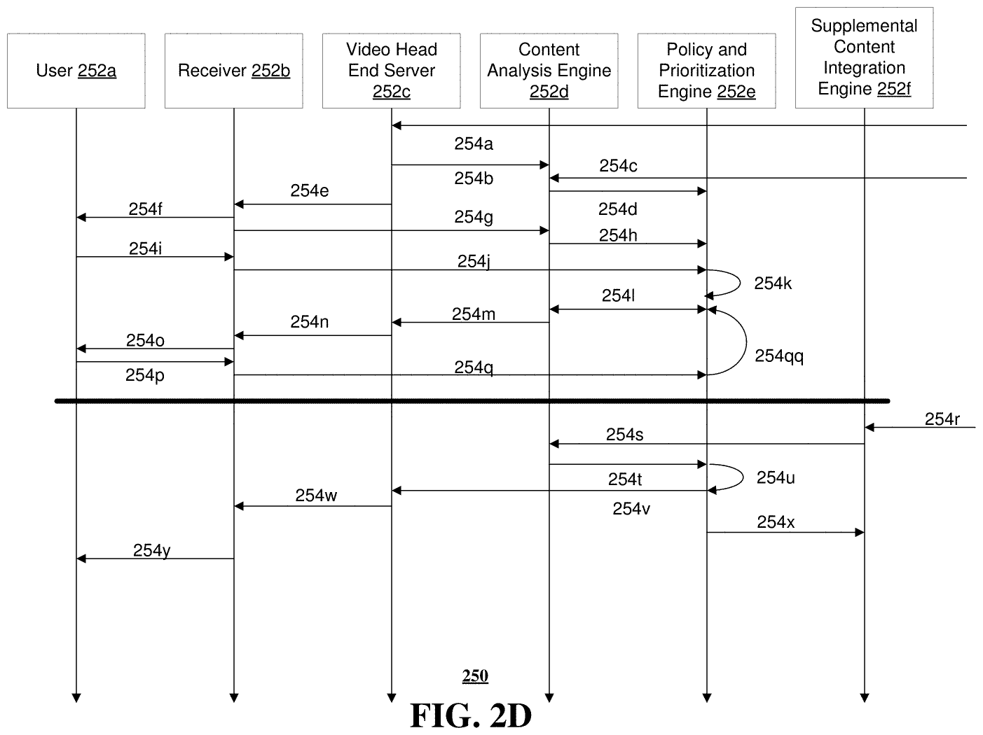

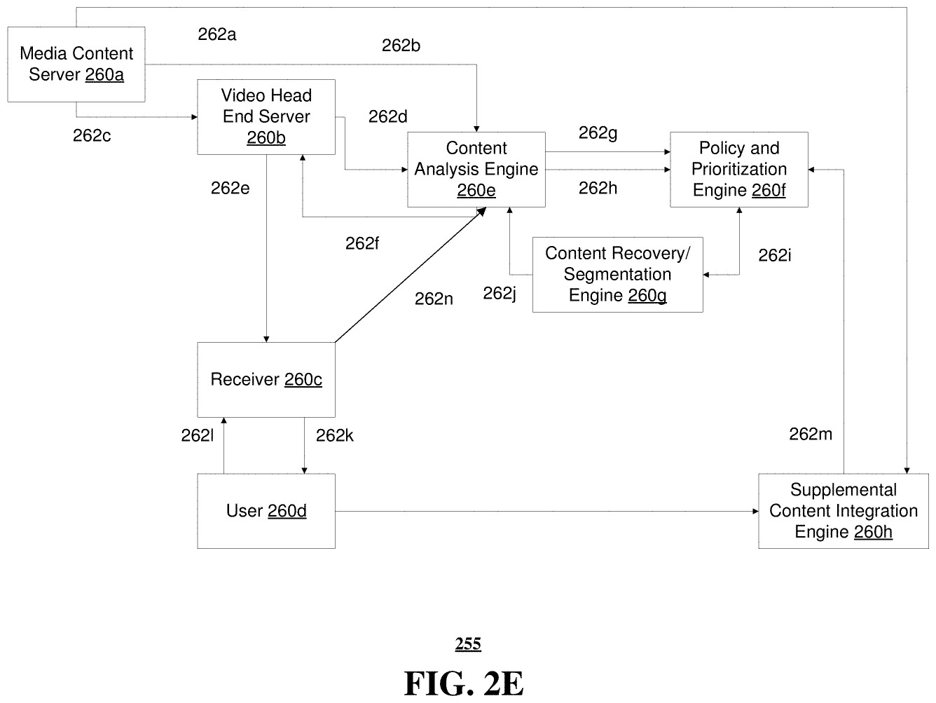

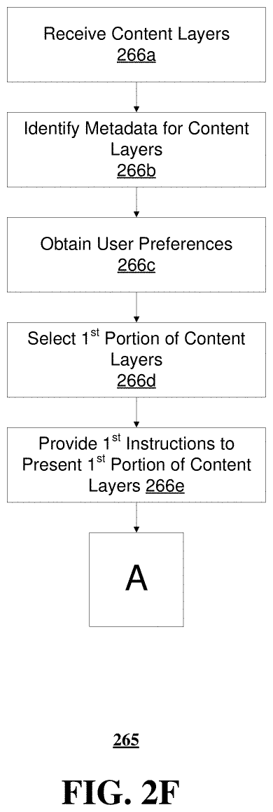

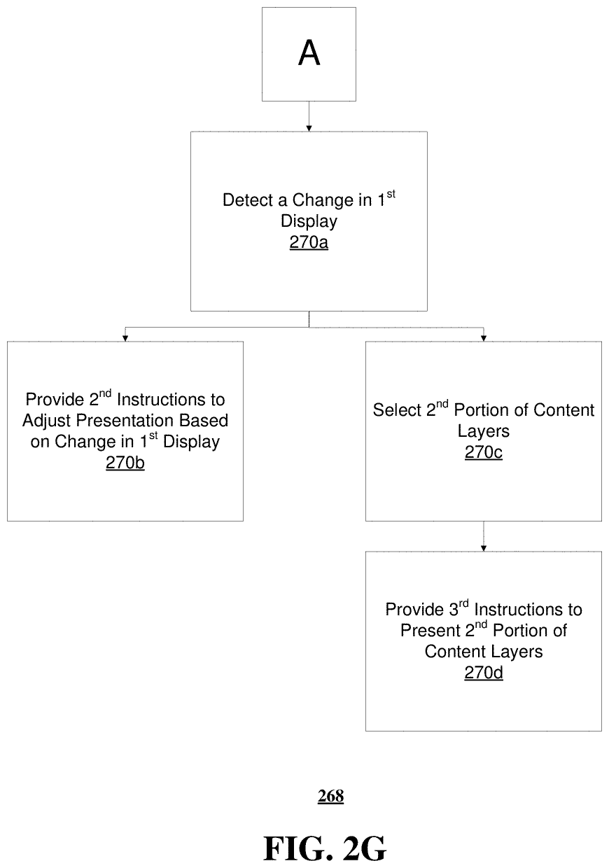

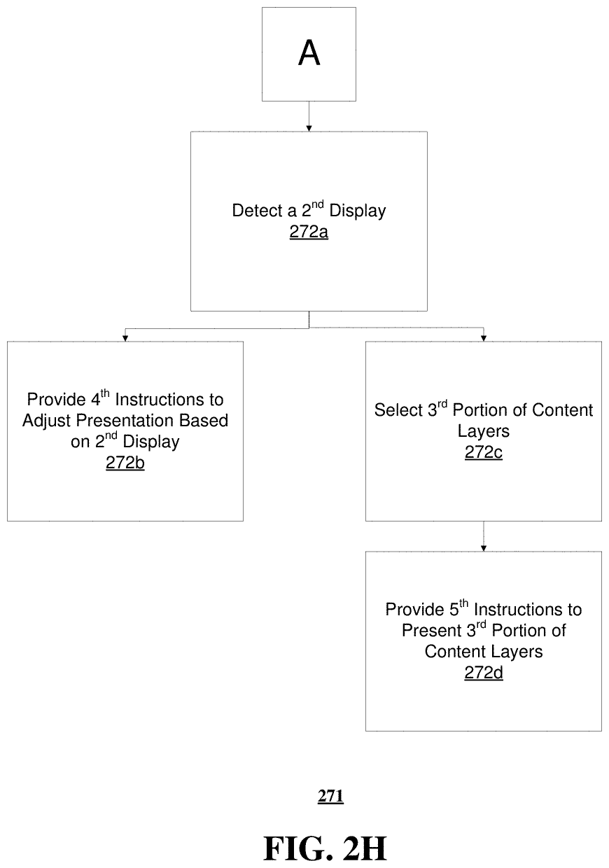

FIGS. 2A-2E are block diagrams illustrating example, non-limiting embodiments of systems functioning within the communication network of FIG. 1 in accordance with various aspects described herein.

In one or more embodiments, a communication device can receive content from many media content sources, which the communication device can be overlayed on each other to obscure each other on a static (or virtual) image plane when presenting the different content in a layered fashion. Such obfuscation can include loss of branding for specific content because of downstream media content sources overlay has no protection or prevention methods of this obfuscating overlay of content layers. Further, most content are not associated with positioning metadata (e.g., mp4 metadata). In addition, new media content needs to account for real-world substitutions (e.g., Coke® vs. Pepsi®). Also, content layers that comprise time-sensitive alerts for weather, political actions, local events may also be overlaid on, and thereby obfuscate other content layers when presented on a display associated with the communication device.

In one or more embodiments, a system can include analysis of content at a video head end, receiver (e.g., communication device), and user client to detect, segment, prioritize, and re-render various content layers from original content and second-party additional layers of content. The analysis can include: detect, segment, and recover underlying or original content; prioritization and policy enforcement; and content integration. The analysis steps detect, segment, and recover underlying or original content that can include detection and segmentation of regions of content utilizing computer vision and audio techniques. It can further include recovering content utilizing Generative Adversarial Networks (GANs) and in-painting to fill in the blank of an object and area, and then moving the video segment to a new region when presented on a display of a communication device. Prioritization and Policy enforcement can include, after determining priority, utilizing importance of a content layer, textual/information relevance tag, and desired spatial positioning. Content integration can include formal system for modification of content at all points in distribution pipeline for more efficiently utilizing of computational processing power and bandwidth.

In one or more embodiments, a system can implement policy and priority for regions that can include certain areas of the display of a communication device may be for news while others for related content. This can include implementing a dynamic or static policy. That is, a policy can change based on user behavior and change content layout on the display of the communication device associated with the user. For example, a user can view news ticker content if it is moved to disambiguate content from another media content source. A system implementing a content priority that can include ranking different content layers to prioritize one content layer over another in case of a conflict. For example, a weather alert can be ranked higher or have a higher priority than an advertisement. Thus, if presenting both the advertisement and the weather alert obfuscates or distracts viewing the weather alert, the position of the advertisement on the display of the communication device is adjusted accordingly to reduce such distraction or can be removed from being presented on the display. A system can stagger displaying different content layers at different times either by detection or based on the metadata associated with each content layer. For example, weather alerts may be more time sensitive so they may be presented to the user before any advertisement, which can be presented at any time to the user.

In one or more embodiments, a system can police branding by detecting that different content layers from different sources do not conflict with each other. For example, not showing an advertisement for a product from one competitor (e.g., Pepsi®) when a scene from the main media content places a product from another competitor (Coke®). In another example, not showing an advertisement for a product (e.g., Pepsi®) when showing news content for a competitor (e.g., Coke®). Further, the system can also reformat one content layer to complement another content layer. For example, reformatting one content layer for a smaller display (e.g., mobile phone display), or for a larger display (e.g. television, virtual reality headset, etc.). This can include altering the contrast of the content such that different content layers do not obscure or distract from each other.

Referring to FIG. 2A, in one or more embodiments, the system 200 comprises a media content server 202, social media content server 203, an advertisement server 204, and affiliate media content server 206 (can be collectively called media content sources) all of which can be communicatively coupled to a video head end server 210 over a communication network 208. In additional embodiments the video head end server (VHO) may be a federated set of servers comprising a content delivery network (CDN). For the purposes of discussion in this disclosure, the operational details of a VHO and a CDN are the same except that a VHO may operate with linear content (e.g. television or broadcast content) whereas a CDN may operate with on-demand content (e.g. VOD, AVOD, user generated content (UGC), ancillary advertising content (e.g. creatives), etc.). Further, the system 200 can include a communication device 218 communicatively coupled to a display 220 associated with a user 222 and a communication device 214 associated with a user 216. The communication device 218 and communication device 214 can be communicatively coupled to the video head end server 210 over communication network 212. Communication network 208 and communication network 212 can comprise a wireless communication network, a wired communication network, or a combination thereof. Communication device 214 and communication device 218 can include a mobile device, mobile phone, smartphone, media processor, set-top box, tablet computer, laptop computer, desktop computer, Internet-of-Things (IoT) device, wearable device, or any other computing device. A media content server 202, social media server 203, advertisement server 204, affiliate media content server 206, and video head end server 210 can comprise a computer server or a group of computer servers, a virtual server spanning a plurality of computer servers, a cloud server, or a combination thereof.

In one or more embodiments, the video head end server 210 can receive content (i.e., content layer) from each of the media content server 202, social media server 203, advertisement server 204, and affiliate media content server 206. Further, the video head end server 210 can aggregate each content layer to build aggregate media content comprising a group of content layers. In some embodiments, the video head end server 210 can identify metadata for each of the content layers as well obtaining a group of user preferences from each of the communication device 214 and communication device 218. The metadata can indicate the subject matter of the associated content layer, its time sensitivity, and position on a display of any communication device on which it is presented. For example, an affiliate media content server 206 can provide, to the video head end server 210, affiliate media content that comprises metadata indicating the subject matter of the affiliate media content includes an imminent weather warning that should be displayed in the bottom banner when presented on a display of any communication device. Further, the advertisement server 204 can provide advertisement content in which the metadata indicates that advertisement content should be also be displayed on the bottom banner when presented on a display of any communication device, which can obfuscate or at least distract from the imminent weather warning. Based on the metadata for each content layer and the group of user preferences, the video head end server 210 can select a portion of the content layers such that different content layers do not obfuscate each other. Continuing with the above example, the video head end server 210 can select the affiliate media content but not select the advertisement content as selecting both would obscure each other when presented on the display of any communication device. Further, the metadata of the affiliate media content as well as the group of user preferences may indicate the user may prefer the affiliate media content to be presented on the display of the communication device rather than the advertisement content. Further, the video head end server 210 can aggregate the selected content layers resulting in aggregated media content and provide the aggregated media content to communication device 214 or communication device 218 to present on their respective displays 220. In other embodiments, the video head end server 210 can provide all the content layers from each of the media content server 202, social media server 203, advertisement server 204, and affiliate media content server 206 to communication device 214 and/or communication device 218. Further, the video head end server 210 can provide instructions to a display 220 of respective communication devices 214, 218 to present selected content layers.

In one or more embodiments, communication device 214 can detect a change in its display (e.g., from landscape mode to portrait mode). This change in display can be detected by receiving user-generated input or detecting the orientation of the communication device 214. In some embodiments, the communication device 214 can provide instructions to the display to adjust the presentation of the selected content layers according to the change in the display. In other embodiments, the change in display can be provided to the video head end server 210 by the communication device 214 by a signal, message, alert, or notification. Further, the video head end server 210 can provide instruction to the communication device 214 to adjust the presentation of the selected content layers according to the change in the display. For example, the change in display may affect two content layers such that both would be presented in the bottom banner portion of the display. Instead, the instructions can indicate that one content layer to presented above another so as not to obscure each other. In additional embodiments, the video head end server 210 can select different content layers, and provide aggregated media content based on the selection of different content layers due to the change in display. For example, remove one of the content layers for the bottom banner portion of the display and instead select a content layer that would be presented in an upper corner of the display. In further embodiments, the video head end server 210 can provide instructions to the communication device 214 to select the different content layers and/or present the different content layers to present according to the change in display.

In one or more embodiments, the video head end server 210 (or another network element then notify the video head end server 210) can detect communication device 218 associated with display 220. This can be detected by receiving user-generated input or detecting the display 220 of the communication device 218 providing to the video head end server 210 a signal, message, alert, or notification. Further, the video head end server 210 can provide instructions to the communication device 218 to adjust the presentation of the selected content layers according to the display 220 of communication device 218. For example, the display 220 may affect two content layers such that both may be presented in the bottom banner portion of the display 220. Instead, the instructions can indicate that one content layer to presented above another so as not to obscure each other. In additional embodiments, the video head end server 210 can select different content layers which would be positioned in different portions of display 220 when presented, and provide aggregated media content to communication device 218 based on the selection of different content layers due to the display 220. In further embodiments, the video head end server 210 can provide instructions to the communication device 218 (after providing all the content layers to communication device 218) to select the different content layers and/or present the different content layers to present according to the display 220.

In one or more embodiments, the communication device 214 and communication device 218 can receive user-generated input that indicates a portion of the group of user preferences. In some embodiments, the user-generated input can be relayed to the video head end server 210. In additional embodiments the communication device 214, 218 can detect its location and can determine a portion of the group of user preferences according to the location of the communication device 214, 218. Further, the location of communication device 214, 218 can provide its location to the video head end server 210, which can then determine a portion of the group of user preferences according to the location of the communication device 214, 218. In further embodiments, the communication device 214 can obtain internet (web) browsing history associated with a user 216 and determining a portion of the group of user preferences according to the internet browsing history. In some embodiments, the communication device 214 can provide the internet browsing history of a user to the video head end server 210 and the video head end server 210 determines a portion of the group of user preferences according to the internet browsing history.

In some embodiments, the video head end server 210 can provide instructions to the communication device 214, 218 to adjust one content layer according to another content layer in presenting both content layers after determining the two content layers may obfuscate or distract from one another. Further, the communication device 214 can provide instructions to display 220 to adjust one content layer according to another content layer in presenting both content layers so as they do not obfuscate or distract from one another.

Referring to FIG. 2B, in one or more embodiments, a system 235a is provided that comprises a display 238a of a communication device. Further, the display 238a can present different content layers that include a media content layer 240a, corner graphic layer 242a, corner social media layers 243a, caption overlay 244a, bottom banner layer 246a, and affiliate bottom banner layer 248a. For example, the display 238a can be a display for a mobile phone, the media content layer 240a can comprise a news program, the corner graphic layer 242a can comprise a local weather map, the corner graphic social media layer 243a comprises social media regarding local weather, the caption overlay 244a can comprise the closed caption associated with the news program, the bottom banner layer 246a comprises a news ticker associated with the news program, and the affiliate bottom banner layers 248a comprises a news ticker associated with the local weather. Positioning of each content layer on the display 238 can be determined by metadata and/or user preferences and instructions are provided to the display 238a to present each content layer accordingly. The instructions are provided by the communication device associated with the display or a video head end server (via the communication device).

Referring to FIG. 2C, in one or more embodiments, a system 235b is provided that comprises a display 238b. Further, the display 238b can present different content layers that include a media content layer 240b, corner graphic layer 242b, adjusted caption overlay 244b, adjusted affiliate bottom banner layer 248b. For example, the display 238b can be a display for a mobile phone, specifically in a different orientation than the display 238a shown in FIG. 2B. Further, the media content layer 240b can comprise a news program, the corner graphic layer 242b can comprise a local weather map, the adjusted caption overlay 244b can comprise the closed caption associated with the news program, the adjusted affiliate bottom banner layers 248a comprises a news ticker associated with the local weather. That is, the font of the caption overlay 244a could be a color that blends with the media content 240b such that the adjusted caption overlay 244b includes font that is in a color that does not blend with the media content 240b. Further, due to the differences in display 238a and display 238b, the bottom banner layer 246a could have obscured affiliate bottom banner layer 248b. Thus, for display 238b, the bottom banner layer 246a is removed according to a change or difference of display 238a from display 238b such that the affiliate bottom banner layer is adjusted to be positioned the length of the display 238b.

Referring to FIG. 2D, in one or more embodiments, the system 250 can include user 252a, receiver 252b (communication device), video head end server 252c, content analysis engine 252d, policy prioritization engine 252e, and supplemental content integration engine 252f. In some embodiments, the video head end server 252c comprises the content analysis engine 252d, the policy and prioritization engine 252e, and the supplemental content engine 252f. In other embodiments, the receiver 252b (communication device) comprises the content analysis engine 252d, the policy and prioritization engine 252e, and the supplemental content engine 252f. In additional embodiments, portions of the content analysis engine 252d, the policy and prioritization engine 252e, and the supplemental content engine 252f can be part of the video head end server 252c and in other embodiments the content analysis engine 252d, the policy and prioritization engine 252e, and the supplemental content engine 252f can be part of the receiver 252b (communication device). The content analysis engine 252d, the policy and prioritization engine 252e, and the supplemental content engine 252f can comprise software and hardware components such as a computer processor and memory as well as can be virtual machines spanning one or more computing devices.

In one or more embodiments, the aggregation service for content layers is enabled for aggregated content delivery. This can include intercepting content sent to the video head end server 252c that comes from upstream media content sources such as video on-demand system. Further, the receiver 252b (communication device), and user 252a are also enabled for content forwarding of the service. In addition, the system 250 analyzes of content. In addition, content analysis can include computer vision and audio techniques to segment regions of video, image, and text. Also, content analysis can include additional processing that can perform OCR, ASR, concept classification (for content into different regions of the display of the communication device), and subsequent text analysis with NLP methods. Content analysis can include content recognition and identification of certain appearances, keywords, faces, etc. Further, content can include metadata that describes priorities and objects.

In one or more embodiments, receiver 252b (communication device), which is in content delivery pipeline, can also send data for analysis. This can include content being delivered to the user 252a and locally cached for just-in-time updates. Further, the content can be forwarded to the content analysis engine 252d for comparison between final (adjusted version) and a national (normative) feed. In addition, the content analysis engine 252d can apply priority of content layers by format and consumption time information from the user 252a and receiver 252b (communication device).

In one or more embodiments, the user interaction commands can be sent to the receiver 252b (communication device), which can include pause, fast forward, play, rewind etc. Further, commands can be forwarded to the policy and prioritization engine 252e. In addition, and optimization engine (in video head end server 252c or receiver 252b) can assign priority to different content layers. This can include utilizing segmentation, timing information, available user attention signals, and policies from all contributors (distributor service, source, etc.). Also, for a content layer that can be obscured by others, additional computer vision methods (GAN) can be used to recover original content. Further, content delivery can begin towards user 252a with priority of content layers. This can include the video head end server 252c and/or receiver 252b (communication device) caching region-level priority regions (e.g., weather maps) and forward to receiver 252b (communication device). Further, the system 250 can recover and format/adjust a new content layer for a user as needed (sizing, contrast, etc.). In addition, user feedback and suppression for feedback can be sent to various components of system 250. Feedback can be aggregated for priority learnings and adjustments within the system 250. This can include discovering a new type of infographic map (e.g., pandemic spread probability) that is higher priority than weather but lower priority than branding.

In one or more embodiments, the video head end server 252c can receive, at 254a, content layers each from a different media content source. Further, the content analysis engine 252d can analyze, at 254b, the content layers as an original stream. In addition, the content analysis engine 252d can receive, at 254c metadata from each of the media content sources. Also, the content analysis engine 252d can provide, at 254d, segment regions of video, perform OCR, and/or textual/NLP analysis. Further, the video head end server 252c can stream, at 254e, the content layers to the receiver 252b (communication device). In addition, the receiver 252b (communication device) can deliver, at 254f, the content layers to the user. Also, the content analysis engine 252d can implement, at 254g, a video comparison using the original stream as a reference. Further, the content analysis engine 252d and the policy and prioritization engine 252e can segment, at 254h, in different regions of the display and prioritize content layers to present a content layer in a different region of the display that can include based on format and consumption time.

In one or more embodiments, the user 252a can pause, fast forward, or otherwise interact, at 254i, with one or more of the different content layers. Further, the interaction/command can be forwarded, at 254j, to the content analysis engine 252d. In addition, the policy and prioritization engine 252e can, at 254k, optimize presentation of the content layers for positioning, priority for timing, available user attention, and policies to prevent overlay. In some embodiments, the optimizations may operate exclusively on overlay positionings that do not obfuscate any of the content or that is selected to reduce obfuscation or that is selected to only obfuscate portions of content that have been determined to meet a threshold (e.g., a threshold for a portion of one content layer overlapping with another content layer, or a distance threshold between two content layers such that one content layer distracts from another content layer).

Also, the content analysis engine 252d and policy and prioritization engine 252e can implement, at 254l, GAN for recovery of objects or portions of displays previously obscured. Further, the content analysis engine 252d can implement, at 254m, just-in-time update for positioning viewing. In addition, the video head end server 252c, can pass, at 254n, through new media content and personalized assembly of aggregated media content with user's social media feed to the receiver 252b (communication device). Also, the receiver 252b (communication device) can implement, at 254o, format adjustment and delivery to user and text rendering (size, contrast, etc.). Further, the user 252a can implement, at 254p, suppression to emergency off feedback request. In addition, the receiver 252b (communication device) can associate, at 254q, with target regions for user-driven policy request. Also, the policy and prioritization engine 252e can provide, at 254qq, feedback and modification of view and additional learning of content layer importance for various viewing segments.

In one or more embodiments, system 250 can implement an injection of new media content. The supplemental content integration engine 254f can receive, at 254r, time sensitive news, weather, etc. Further, the content analysis engine 254d can provide, at 254s, priority, content and positioning suggestion. In addition, the content analysis engine 254d can add, at 254t, a level of priority by classification for emergency need and user-sensitivity. Also, the policy and prioritization engine 252e can include or reject, at 254u, a content layer by user impact and available attention. Further, the policy and prioritization can implement, at 254v, just-in-time update for positioning and view. In addition, the video head end server 252c can pass through the new media content, or personalized user's social media feed, at 254w. The receiver 252b (communication device) can implement, at 254y, format adjustment and delivery to user.

Referring to FIG. 2E, in one or more embodiments, system 255 can include a media content server 260a, video head end server 260b, receiver 260c (communication device), user 260d, content analysis engine 260e, policy prioritization engine 260f, content recovery/segmentation engine 260g, and supplemental content integration engine 260h all of which are in communication with each other over one or more communication networks. In some embodiments, the video head end server 260b can comprise the content analysis engine 260e, policy prioritization engine 260f, content recovery/segmentation engine 260g, and supplemental content integration engine 260h. In other embodiments, the receiver 260c (communication device) can comprise the content analysis engine 260e, policy prioritization engine 260f, content recovery/segmentation engine 260g, and supplemental content integration engine 260h. The content analysis engine 260e, policy prioritization engine 260f, content recovery/segmentation engine 260g, and supplemental content integration engine 260h can comprise software and hardware components such as a computer processor and memory as well as can be virtual machines spanning one or more computing devices.

In one or more embodiments, the media content server 260a can provide, at 262a, data/content layers to the supplemental content integration engine 260h, which can include time sensitive video or news updates as new or secondary additional content layers to overlay a primary (main) media content layer. Further, the media content server 260a can provide, at 262b, content layers and metadata to the content analysis engine 260e. In addition, the media content server 260a can provide at 262c, content layers and metadata to the video head end server 260b. Also, the video head end server 260b can provide, at 262e, data/content layers to the receiver 260c (communication device). The content analysis engine 260e can provide, at 262f, data to the video head end server 260b, which can include data/content layers with new updates. Further, the content analysis engine 260e can provide, at 262g, data/content layers, which can include presenting them on different segments of a display. In addition, the content analysis engine 260e can provide, at 262h, data, which can include user interactions, to find differences between receiver stream and head-end stream. Also, the policy and prioritization engine 260f and the content, recovery/segmentation engine 260g can exchange, at 262i, data, which includes video segmentation and recovery, generation with GAN or in-painting. Further, the content recovery/segmentation engine, at 260g, can provide, at 262j, data/content layers, which can include new updates and overlays. In addition, the user can provide, at 262l user interactions to the receiver 260c. Also, the receiver 260c (communication device) can present data/content layers to the user. The supplemental content engine 260h can provide, at 262m, data/content layers overlaid on each other, which can include new content layers, target regions of a display for the content layers, and priority requests. Further, the receiver 260c (communication device) can provide, at 262n, data/content layers, timing metadata, audience metadata, and/or user interactions.

FIGS. 2F-H depicts an illustrative embodiment of a method in accordance with various aspects described herein. In one or more embodiments, a video head end server or a communication device, described herein, can implement the methods shown in FIG. 2F-2H. The method 265 can include the video head end server, at 266a, receiving a group of content layers from a group of media content sources. Further, the method 265 can include the video head end server, at 266b, identifying metadata for each of the group of content layers resulting in a group of metadata. In addition, the method 265 can include the video head end server, at 266c, obtaining a group of user preferences. Also, the method 265 can include the video head end server, at 266d, selecting a first portion of the group of content layers according to the group of metadata and the group of user preferences resulting in a first selected portion of the group of content layers. The method 265 can include the video head end server, at 266e, providing first instructions to a first display of a first communication device to present the first selected portion of the group of content layers resulting in a first presentation.

Referring to FIG. 2G, in one or more embodiments, the method 268 can include the video head end server, at 270a, detecting a change in the first display of the first communication device. This can include a change in orientation of the first display. For example, the display can be changed from a landscape orientation to a portrait orientation. Further, the method 268 can include the video head end server, at 270b, providing second instructions to the first display of the first communication device to adjust the first presentation to a second presentation of the first selected portion of the group of content layers according to the change in the first display. In addition, the method 268, can include the video head end server, at 270c, selecting a second portion of the group of content layers according to the group of metadata, the group of user preferences, and the change in display resulting in a second selected portion of the group of content layers. Also, the method 268, can include the video head end server, at 270d, providing third instructions to the first display of the first communication device to present the second selected portion of the group of content layers resulting in a third presentation.

Referring to FIG. 2H, in one or more embodiments, the method 271 can include the video head end server, at 272a, detecting a second display of a second communication device. Further, the method 271 can include the video head end server, at 272b, providing fourth instructions to the second display of the second communication device to adjust the first presentation to a fourth presentation of the first selected portion of the group of content layers according to the second display. In addition, the method 271 can include the video head end server, at 272c, selecting a third portion of the group of content layers according to the group of metadata, the group of user preferences, and the second display resulting in a third selected portion of the group of content layers. Also, the method 271 can include the video head end server, at 272d, providing fifth instructions to the second display of the second communication device to present the third selected portion of the group of content layers resulting in a fifth presentation.

In one or more embodiments, the group of content layers is selected from the group of a main content layer, corner content overlay, bottom banner overlay, top banner overlay, main source overlay, an affiliate overlay, social media overlay, advertisement overlay, social media feed/post, etc. or a combination thereof. Further, the methods as described herein, can include the video head end server receiving user-generated input, the user-generated input indicates a first portion of the group of user preferences. In addition, the methods as described herein, can include the video head end server detecting a location of the first communication device, and determining a second portion of the group of user preferences according to the location of the first communication device. Also, the methods as described herein, the video head end server obtaining internet browsing history associated with a user, and determining a third portion of the group of user preferences according to the internet browsing history associated with the user.

Further, the methods as described herein, can include selecting a first portion of the group of content layers according to the group of metadata, the group of user preferences, and a second portion of the group of content layers resulting in a first selected portion of the group of content layers, and providing first instructions to a first display of a first communication device to present the first selected portion of the group of content layers resulting in a first presentation, wherein the second portion of the group of content layers distracts from the first selected portion of the group of content layers when the first selected portion of the group of content layers and the second portion of the group of content layers are presented on the first display simultaneously.

Further, the methods as described herein, can include the selecting of the first portion of the group of content layers comprises selecting the first portion of the group of content layers according a fourth portion of the group of content layers. In addition, the first instructions comprise instructions to adjust a first content layer in the first selected portion of the group of content layers according to a second content layer in the first selected portion of the group of content layers, wherein the second portion of the group of content layers distracts from or obfuscates the first selected portion of the group of content layers when/if presented the first content layer in the first selected portion of the group of content layers and the second content layer in the first selected portion of the group of content layers are on the first display simultaneously.

In one or more embodiments, media content layers that can be overlayed on each other are analyzed to position them on the communication device of a user so as to not obfuscate each other. Further, media content layers that can be overlayed on each other are analyzed to present them at times on the communication device associated with a user that may have an impact on the user (e.g., based on the user preferences). In addition, machine learning can be utilized around a policy for overlaying different combination of media content layers. Also, integration (overlaying) of content layers with other content layers onto an existing presentation on a display. In further embodiments, media content sources can provide metadata for each content layer indicating priority of each content layer to present/overlay on a display of communication device associated with the user. In additional embodiments, notification of acceptance/rejection of overlaying a media content layer can be given to a media content source from a policy and prioritization engine/system.

In one or more embodiments, a personal social media feed can be integrated as a content layer in a presentation on a display of a communication device as well as integrating it according to its prioritization and timeliness. Further, content layers are included in a presentation based on monitoring presentation of other content being presented on a communication device to better derive user preferences (e.g., if certain aged population prefers large bottom banner content, prefer weather content layers to be presented over other types of content layers, etc.). In some embodiments, content analysis can indicate a priority and policy such as faces, logo, brand images, product images, etc. that should not be obfuscated or distracted by other content layers. In other embodiments, content layers can be purposely be retrieved based on user behavioral measures and interactions. In further embodiments, sound and color of content layers can be leveled in multisource environments.

While for purposes of simplicity of explanation, the respective processes are shown and described as a series of blocks in FIGS. 2F-2H, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein. In some embodiments, portions of some of the methods described in FIGS. 2D-2H can be combined with portions of other methods described in FIGS. 2D-2H. Further, in other embodiments, a block in methods described in FIGS. 2D-2H can be performed in response to another block in methods described in FIGS. 2D-2H.

Portions of some embodiments described herein can be combined with portions of other embodiments.

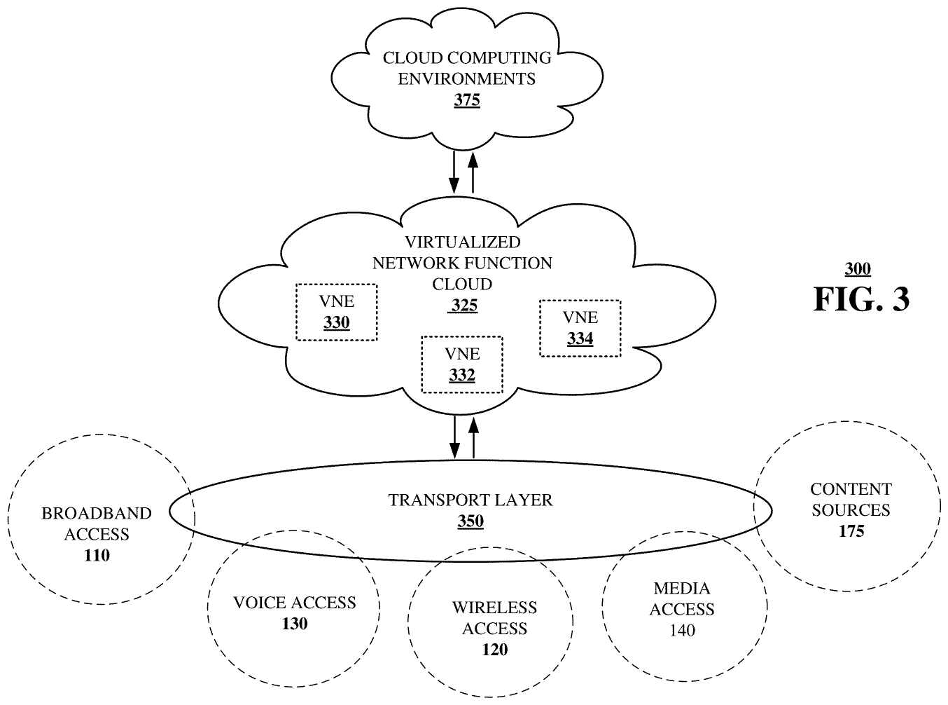

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of systems, and methods presented in FIGS. 1, 2A-2H, and 3. For example, virtualized communication network 300 can facilitate in whole or in part selecting a portion of media content layers to present on a communication device of a user based on metadata of the content layers and user preferences and providing instructions to the display of the communication device accordingly.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

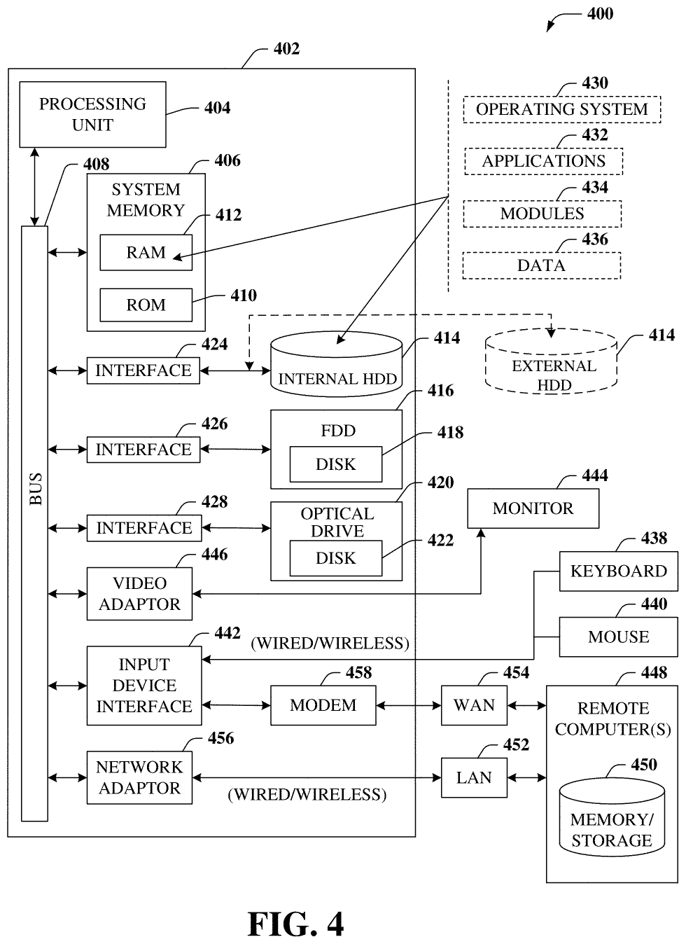

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part selecting a portion of media content layers to present on a communication device of a user based on metadata of the content layers and user preferences and providing instructions to the display of the communication device accordingly. Further, the servers, communication devices, displays, receiver, content analysis engine, policy and prioritization engine, supplemental content integration engine, and content recovery/segmentation engine can comprise computing environment 400.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures.

The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

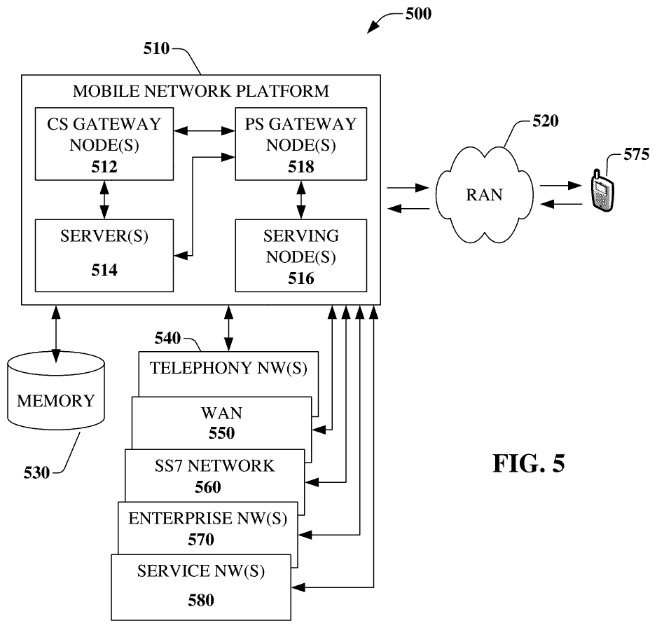

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part selecting a portion of media content layers to present on a communication device of a user based on metadata of the content layers and user preferences and providing instructions to the display of the communication device accordingly. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

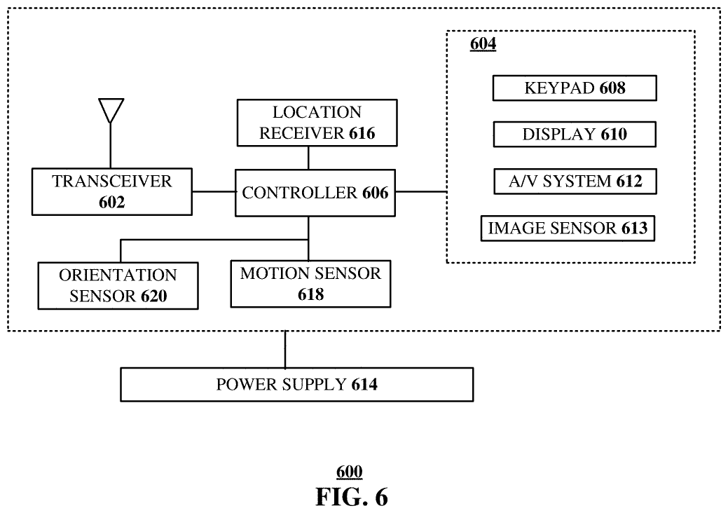

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part selecting a portion of media content layers to present on a communication device of a user based on metadata of the content layers and user preferences and providing instructions to the display of the communication device accordingly. Further, the servers, communication devices, displays, receiver, content analysis engine, policy and prioritization engine, supplemental content integration engine, and content recovery/segmentation engine can comprise communication device 600.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

1. A device, comprising:
a processing system including a processor; and
a memory that stores executable instructions that, when executed by the processing system, facilitate performance of operations, the operations comprising:
receiving a group of content layers from a group of media content sources;
identifying metadata for each content layer of the group of content layers resulting in a group of metadata, the metadata for each content layer of the group of content layers comprising:
an indication of a subject matter of the content layer, a time sensitivity of the content layer, and a position on a display of the content layer;
obtaining a group of user preferences;
selecting a first portion of the group of content layers according to the group of metadata and the group of user preferences resulting in a first selected portion of the group of content layers; and
providing first instructions to a first display of a first communication device to present the first selected portion of the group of content layers resulting in a first presentation.

2. The device of claim 1, wherein the operations further comprise:
detecting a change in the first display of the first communication device.

3. The device of claim 2, wherein operations further comprise:
providing second instructions to the first display of the first communication device to adjust the first presentation to a second presentation of the first selected portion of the group of content layers according to the change in the first display.

4. The device of claim 3, wherein the operations further comprise:
selecting a second portion of the group of content layers according to the group of metadata, the group of user preferences, and the change in display resulting in a second selected portion of the group of content layers; and
providing third instructions to the first display of the first communication device to present the second selected portion of the group of content layers resulting in a third presentation.

5. The device of claim 1, wherein the group of content layers is selected from the group consisting of a main content layer, corner content overlay, bottom banner overlay, top banner overlay, main source overlay, an affiliate overlay, social media overlay, advertisement overlay, or a combination thereof.

6. The device of claim 1, wherein the operations comprise:
detecting a second display of a second communication device.

7. The device of claim 6, wherein the operations further comprise:
providing second instructions to the second display of the second communication device to adjust the first presentation to a second presentation of the first selected portion of the group of content layers according to the second display.

8. The device of claim 7, wherein the operations further comprise:
selecting a second portion of the group of content layers according to the group of metadata, the group of user preferences, and the detecting of the second display resulting in a second selected portion of the group of content layers; and
providing third instructions to the second display of the second communication device to present the second selected portion of the group of content layers resulting in a third presentation.

9. The device of claim 1, wherein the operations further comprise:
receiving a user-generated input, wherein the user-generated input indicates a first portion of the group of user preferences.

10. The device of claim 1, wherein the operations further comprise:
detecting a location of the first communication device, wherein a first portion of the group of user preferences are determined according to the location of the first communication device.

11. The device of claim 1, wherein the operations further comprise:
obtaining internet browsing history associated with a user, wherein a first portion of the group of user preferences are determined according to the internet browsing history associated with the user.

12. The device of claim 1, wherein the selecting of the first portion of the group of content layers comprises selecting the first portion of the group of content layers according to a second portion of the group of content layers.

13. A non-transitory machine-readable medium, comprising executable instructions that, when executed by a processing system including a processor, facilitate performance of operations, the operations comprising:
receiving a group of content layers from a group of media content sources;
identifying metadata for each content layer of the group of content layers resulting in a group of metadata, the metadata for each content layer of the group of content layers comprising: an indication of a subject matter of the content layer, a time sensitivity of the content layer, and a position on a display of the content layer;
obtaining a group of user preferences;
selecting a first portion of the group of content layers according to the group of metadata and the group of user preferences and according to a determination that a second portion of the group of content layers would distract from the first portion of the group of content layers if the first portion of the group of content layers and the second portion of the group of content layers were to be presented on a first display of a first communication device simultaneously; and
providing, based on the selecting, first instructions to the first communication device to present, via the first display, the first portion of the group of content layers resulting in a first presentation.

14. The non-transitory machine-readable medium of claim 13, wherein the first instructions comprise instructions to adjust a first content layer in the first portion of the group of content layers according to a second content layer in the first portion of the group of content layers.

15. The non-transitory machine-readable medium of claim 13, wherein the operations comprise detecting a second display of a second communication device.

16. The non-transitory machine-readable medium of claim 15, wherein operations further comprise providing second instructions to the second display of the second communication device to adjust the first presentation to a second presentation of the first portion of the group of content layers according to the detecting of the second display.

17. The non-transitory machine-readable medium of claim 16, wherein the operations further comprise:
selecting a third portion of the group of content layers according to the group of metadata, the group of user preferences, and the detecting of the second display; and
providing third instructions to the second display of the second communication device to present the third portion of the group of content layers resulting in a third presentation.

18. A method, comprising:
receiving, by a processing system including a processor, a group of content layers from a group of media content sources;
identifying, by the processing system, metadata for each content layer of the group of content layers resulting in a group of metadata, the metadata for each content layer of the group of content layers comprising: an indication of a subject matter of the content layer, a time sensitivity of the content layer, and a position on a display of the content layer;
obtaining, by the processing system, a group of user preferences;
selecting, by the processing system, a first portion of the group of content layers according to the group of metadata and the group of user preferences resulting in a first selected portion of the group of content layers; and
providing, by the processing system and based on the selecting, first instructions to a first communication device to present, via a first display of the first communication device, the first portion of the group of content layers resulting in a first presentation, wherein the first instructions comprise instructions to adjust a first content layer in the first portion of the group of content layers according to a second content layer in the first portion of the group of content layers resulting in an adjustment, wherein in an absence of the adjustment the first content layer in the first portion of the group of content layers would distract from the second content layer in the first portion of the group of content layers when the first content layer in the first portion of the group of content layers and the second content layer in the first portion of the group of content layers are presented on the first display simultaneously.

19. The method of claim 18, comprising:
detecting, by the processing system, a change in the first display of the first communication device; and
providing, by the processing system, second instructions to the first communication device to adjust the first presentation to a second presentation of the first portion of the group of content layers according to the change in the first display.

20. The method of claim 19, comprising:
selecting, by the processing system, a second portion of the group of content layers according to the group of metadata, the group of user preferences, and the detecting of the change in the first display; and
providing, by the processing system and based on the selecting of the second portion of the group of content layers, third instructions to the first communication device to present, via the first display, the second portion of the group of content layers resulting in a third presentation.
